(19) United States
(12) Patent Application Publication
(10) Pub. No.: US 2019/0168436 A1
(43) Pub. Date: Jun. 6, 2019

(54) Fused Deposition Modeling Filament Production Apparatus

(71) Applicant: 3DEVO B.V., Utrecht (NL)

(72) Inventors: Tim WESSELINK, Utrecht (NL); Lucas VAN LEEUWEN, Utrecht (NL)

(21) Appl. No.: 16/308,135

(22) PCT Filed: Jun. 9, 2017
(86) PCT No.: PCT/EP2017/064150

§ 371 Date: Dec. 7, 2018

(30) Foreign Application Priority Data
Jun. 9, 2016 (NL) 2016921

(51) Int. Cl. B29C 48/05; B29C 48/08; B29C 48/88; B29C 48/28; B65H 51/10

(52) U.S. Cl. CPC B29C 48/05; B29C 48/08; B33Y 70/00; B29C 48/28; B65H 51/10; B29C 48/911

(57) ABSTRACT

A fused deposition modeling filament production apparatus including an extrusion unit comprising an extruder, feeding means for feeding FDM raw material into the extrusion unit, a filament discharge at an end of the extruder, a filament cooling unit linked to the filament discharge, a filament buffer unit for receiving and storing the filament from the cooling unit. The extrusion unit, the filament cooling unit and the filament buffer unit are accommodated in a frame. The extrusion unit is horizontally accommodated in a top section of the frame, having the feeding means on top of the extrusion unit and extending vertically from the extrusion unit. The filament discharge is arranged for substantially vertically downward discharging the extruded filament from the extrusion unit. The filament cooling unit and filament buffer unit are accommodated in a lower section of the frame below the extrusion unit.

### FIELD OF THE INVENTION

The invention relates to a fused deposition modeling filament production apparatus.

### BACKGROUND OF THE INVENTION

Fused deposition modelling (FDM) also known as 3D printing is becoming available in both professional and private environments. Various materials can be printed into a wide variety of printed objects. Most objects are modeled by feeding an FDM material into an FDM or 3D printer which fuses the material and the objects are made. The fusing can be a thermal process wherein the FDM material is molten and subsequently fused to previously deposited parts of the object. The previously deposited parts of the object are very often layers of the FDM material. The FDM material in such thermal process is usually a thermoplastic material. The deposition and fusion of the molten material requires a steady flow of material. Thus, the thermoplastic material in a large variety of 3D printers is provided as a filament, an FDM filament. The material however is not limited to thermoplastic. It can also be any other material suitable for FDM or 3D printing provided that it can be cast into a filament. Other examples comprise (glass) fiber reinforced plastics, or plastics with a wood or metal filler, or plastics filled with for example piezo-electric particles or nano circuits.

FDM filament is usually efficiently produced off line in factories on a large scale at relatively low cost. Also, relatively high quality can be maintained as the manufacturing equipment can be very well tuned for mass production. The produced filament is subsequently provided on reels which can be loaded into a local FDM or 3D printer for the various purpose and applications.

For product developers or scientists exploring new FDM applications standard FDM materials do not meet their needs, as they may want to experiment with various material compositions. Ordering FDM materials adapted for specific purposes may be expensive if possible at all. Moreover, materials used in FDM objects, or other objects may be recycled and re-used in the FDM printing. An example is polyethylene, which is very used in for example soda bottles. This material is very suitable for recycling and re-use in FDM printing. Another example is acrylonitrile butadiene styrene (ABS), which is commonly used in larger plastic objects such as chairs, computers covers and more.

Thus a demand is growing for FDM filament production on a small scale allowing a free choice of FDM material compositions and additives such as coloring which can be utilized in homes, offices and laboratories. This enables researchers, students, artists to further develop FDM materials and bring FDM or 3D printing to a new level.

Known small scale FDM production units allow raw materials in shredded form to be extruded into FDM filament. Such production units however tend to lack the accuracy required to produce FDM filaments with constant composition and size. Varying FDM filament quality, causes varying quality of the FDM objects made from these materials.

### SUMMARY OF THE INVENTION

It is therefore an object to provide a fused deposition modeling filament production apparatus which is suitable for producing filament on a small scale, while maintaining stable filament cross section with high accuracy of the produced filament diameter.

The object is achieved in a fused deposition modeling filament production apparatus comprising an extrusion unit comprising an extruder, feeding means for feeding FDM raw material into the extrusion unit, a filament discharge at an end of the extruder, a filament cooling unit linked to the filament discharge, a filament buffer unit for receiving and storing the filament from the cooling unit. The extrusion unit, the filament cooling unit and the filament buffer unit are accommodated in a frame. The extrusion unit is horizontally accommodated in a top section of the frame, having the feeding means on top of the extrusion unit and extending vertically from the extrusion unit. The filament discharge is arranged for substantially vertically downward discharging the extruded filament from the extrusion unit. The filament cooling unit and filament buffer unit are accommodated in a lower section of the frame below the extrusion unit.

The combination of horizontally oriented extruder and vertical discharge opening or nozzle allows optimal use of gravity. The feeding means arranged vertically on top of the horizontal extruder allows the FDM material to be captured and transported by a screw or shaft in the extruder barrel, which is arranged as a horizontally oriented tube. A vertically arranged extruder, and subsequently extruder screw would not have this advantage for FDM material in the form of granulate, and would require additional features to ensure proper feeding of the material in granulate form. For small scale production of FDM filament from shredded, granulate material using the filament production apparatus the orientation of the extruder relative to the feeding means is most advantageous, as it does not require any further feeding and mixing means other than the extruder and extruder screw itself.

Moreover, it is most advantageous to have a vertical downward discharge of the filament from the extrusion unit. This allows a cross section of the filament to be maintained in a same circumferential form or profile. For example, in case of a circular discharge opening, the filament will keep a circular cross section while flowing out of the discharge opening. When horizontally discharging the extruded filament and subsequently vertically further processing the filament, the cross section would become ovally or ellipsoidally distorted due to gravity and bending of the filament material while it is still hot and flexible. Thus, the vertically oriented discharge opening or nozzle allows the cross section of the extruded filament, determined by the cross section of the discharge opening at the moment of extrusion, to be maintained after the extrusion, even when the extruded filament may stretch due to gravity. So this cross section is maintained despite the influence of gravity on the hot filament exposed to this gravity. Any deformation due to gravity will be homogeneous in a horizontal direction. Thus, gravity has no adverse effect on the filament cross section after extrusion.

As an additional advantage, the vertical discharge opening allows a mutual position of the cooling unit and buffer below the extruder, which enable a compact design of the filament production apparatus with relatively low dimensions in horizontal and vertical direction, and make it particularly suitable for small scale use in for example an artist's office or studio.

In an embodiment, the extruder comprises an extruder barrel, a rotary extrusion shaft arranged within the extruder barrel, and a drive for driving the rotary extrusion shaft. The drive can be connected and controlled by a control unit, which allows the extrusion unit to produce FDM filament at a rate previously set.

In an embodiment, the filament discharge opening, when extending horizontally from the extrusion unit can have a right angle bend having its horizontal leg attached to the extrusion unit, i.e. barrel, whereas the filament discharge opening is disposed at the vertical leg end.

In a further embodiment, the extruder comprises at least one heating element for heating the extruder barrel. The heating elements can be spaced along the extruder barrel to allow the creation of a temperature profile. Thereby, the extrusion unit can be adaptable for various materials, which may require a specific temperature profile along the extrusion extruder barrel.

In an embodiment, the buffer unit comprises a reel holder, a reel holder drive and an access port for introducing a reel into the buffer unit for storing the filament from the cooling unit, and filament guide for evenly winding the filament onto the reel. This allows the FDM filament manufacturing apparatus to produce FDM filament off-line. The filament is stored onto the reel, which reel can be exchanged with an empty reel when filled.

In an embodiment, the buffer unit comprises a container wherein the filament from the cooling unit can be stored, and coiling means for coiling up the filament from the cooling unit within the container, and a filament output port for outputting the coiled up filament from the container.

This allows the FDM filament manufacturing apparatus to be used online while printing is in progress. In this case the filament can be output from the apparatus and fed into the FDM printer. The buffer ensures that differences in filament production rate of the FDM filament manufacturing apparatus and the FDM printer are accommodated.

In a further embodiment, the coiling means comprise a rotator and a rotatable guide mounted on the rotator, wherein the rotatable guide is arranged for feeding the filament through the rotator and for tangentially releasing and coiling the filament in opposite direction relative to the rotational direction of the rotator.

In an embodiment, the cooling unit is arranged having a port at a top end for receiving the filament from the filament discharge, and transport means for substantially vertically transporting the filament through the cooling means. The transport means allows the filament to be pulled through the cooling unit.

In an embodiment, the cooling means comprise a blower arranged for blowing air onto the filament received from the filament discharge. Using air allows the just extruded filament to cool wherein no contact other than air with the hot filament is required. This advantageous, as this prevents distortion of the just extruded filament.

In an embodiment, the apparatus further comprises a control unit, and wherein the transport means comprise filament stretching means and the control unit is arranged for controlling the filament stretching means. By introducing a difference in production rate of the extrusion unit and the transport means, the amount of stretching can be controlled. The stretching allows a filament diameter to be controlled.

In an embodiment, the control unit is arranged for controlling the filament stretching means transport rate. The higher the transport rate relative to the production rate, the more stretching is performed, the thinner the filament will be.

In an embodiment, the control unit is arranged for controlling the filament stretching means transport rate relative to an extruder production rate. By varying the stretching, i.e. the transport rate of the transport means relative to the production rate, the filament diameter can be controlled and a preset diameter can be obtained.

In a further embodiment, the apparatus further comprises a filament diameter sensor connected to the control unit for sending a filament diameter to the control unit, and wherein the control unit is arranged for controlling the filament stretching means transport rate as a function of the filament diameter and a filament diameter set value. This allows to accurately control the filament diameter and obtain high quality filament with a preset diameter value. This preset value may be constant or may vary in time for example continuously or be vary per filament batch to be produced.

In an embodiment, the diameter sensor comprises a light source and an optical imaging device for measuring the filament diameter. This allows contactless measurement of the actual filament diameter which is advantageous, since no pressure needs to be exerted on the filament to obtain its diameter, thus no distortion results.

### BRIEF DESCRIPTION OF THE DRAWINGS

FIG. 1 shows a topology of a fused deposition modelling filament production apparatus according to an embodiment of the invention.

FIG. 2 shows a side view of the FDM production apparatus according to an embodiment of the invention.

FIG. 3a shows a perspective view of the FDM filament production apparatus according to an embodiment of the invention.

FIG. 3b shows a filament diameter sensor and control unit according to an embodiment of the invention.

FIG. 4a shows a front view of the FDM filament production apparatus according to an embodiment of the invention.

FIG. 4b shows a perspective view of the FDM filament production apparatus according to an embodiment of the invention.

FIG. 4c shows a perspective view of the FDM filament production apparatus according to an embodiment of the invention.

FIG. 4d shows a detail of the perspective view of FIG. 4c of the FDM filament production apparatus according to an embodiment of the invention.

FIG. 4e shows a perspective view of the FDM filament production apparatus according to an embodiment of the invention.

### DETAILED DESCRIPTION OF THE INVENTION

In FIG. 1 a basic topology of the FDM filament production apparatus is shown, having an extrusion unit for extruding FDM filament from raw material supplied to the extrusion unit via hopper 102. The extrusion unit 101 can be a small scale or lab extruder suitable for the materials supplied via the hopper 102. The extrusion unit 101 can be provided with heating elements 112 which are placed around the extruder barrel 111 of the extrusion unit 101. The extruder barrel preferably has a filament discharge 103 having its opening directed vertically downwards. As shown in FIG. 1, the filament discharge 103 is formed by a discharge channel having a right angle bend 110, which is horizontally connected to the extruder barrel 111 and which has its discharge opening directed vertically downward.

Filament 105 extruded from the extrusion unit 101 passes downward vertically trough cooling unit 104. The cooling unit lowers the temperature of the filament 105 such that the filament 105 can be guided buffer unit 106 for storing or buffering. The vertical outflow of the filament 105 from the filament discharge 103 assures that the filament cross section is maintained. Horizontal outflow of the filament 105 would cause bending of the filament 105 as it is still hot when discharged from the extrusion unit 101. Bending of the filament 105 would cause a distortion of its cross section, which is undesirable in the production of quality filament.

A guide 113 can be provided to aid proper buffering of the filament 105 in filament buffer 106.

As a certain length L is required for sufficiently cool down and/or processing of the filament 105, a space 107 can be created underneath the extrusion unit 101 which advantageously provides room for accommodating the filament buffer unit 106. The extrusion unit 101 preferably is located in the top section of the FDM filament production apparatus, as its hopper 102 is in that position easily accessible for the user to supply raw material. The extrusion unit 101 has a drive 109 for driving one or more extrusions screws within the extrusion extruder barrel 111. The frame 108a-108d provides support for the extrusion unit 101, with its drive 109, the cooling unit 104 and the filament buffer unit 106.

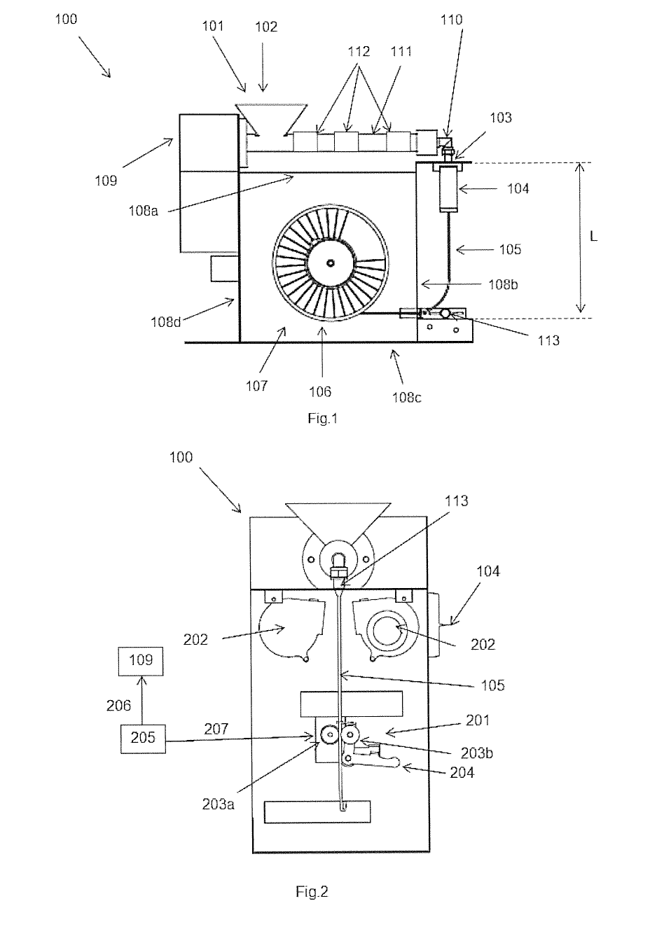

FIG. 2 shows a side view of the FDM production apparatus 100. Centrally on the top section of the apparatus 100 is shown the filament discharge 103 from which filament 105 is discharged vertically downward. The cooling unit 104 is shown arranged at the side panel 108b of the frame. The cooling unit 104 comprises blowers 202 positioned oppositely to each other on both sides of the discharged filament 105.

In FIG. 2, a filament puller 201 is shown, which is arranged to exert a pulling force to the vertically discharged filament 105. As the filament 105 after extrusion has an increased temperature causing the filament to be more flexible. The pulling force can be used to adjust a filament diameter to a required size. The more pulling force exerted to the filament, the thinner the filament diameter will result. The filament cross section profile however will not be affected by the pulling force.

The puller 201 is shown having puller wheels 203a, 203b wherein puller wheel 203b can be positioned on the extruded filament 105 by means of a lever 204. This results in the filament 105 to be clamped between the puller wheels 203a, 203b. By driving one or both of the puller wheels 203a, 203b pulling force is affected on the filament 105. By properly adjusting the pulling force in relation to an extrusion speed, set by the extruder drive 109, the filament diameter of the extruded filament 105 can be controlled. The pulling force can be adjusted by controlling the puller transport rate or speed. The higher the puller transport rate or speed, the higher the pulling force. The controlling can be performed by controller 205 which controls 206, 207 both the extrusion drive 109 and the puller drive, driving either of the puller wheels 203a, 203b.

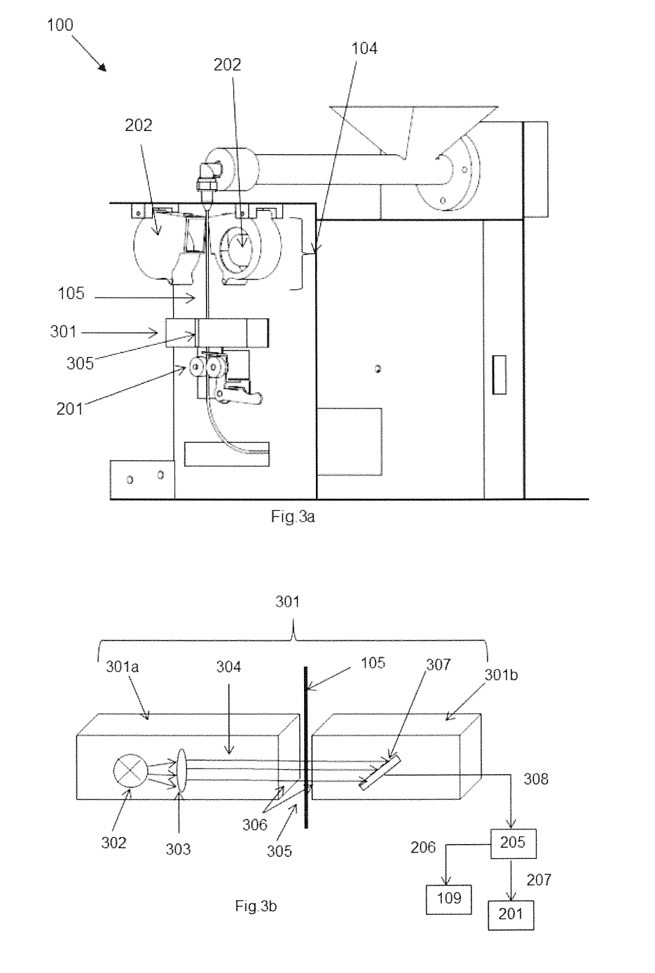

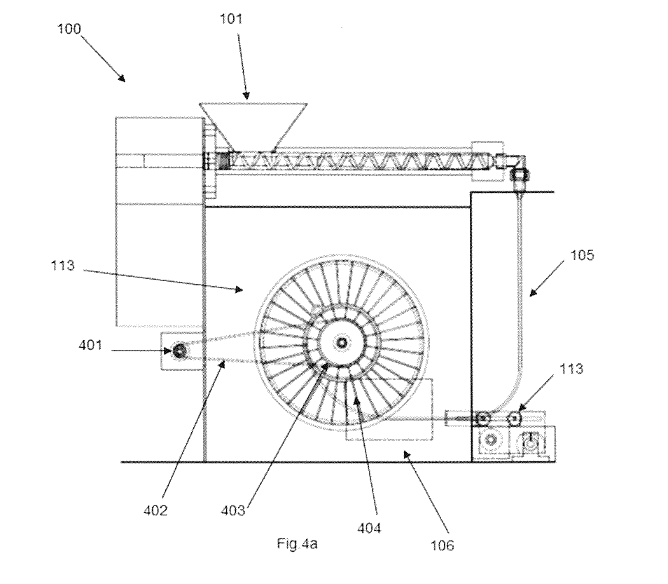

FIG. 3a shows a perspective view of the FDM filament production apparatus 100, or more specifically the side of the FDM filament production apparatus having the cooling unit 104 and the puller 201. FIG. 3a shows a filament diameter sensor 301, which is arranged above the puller 201 for sensing the filament diameter of the filament 105 passing through a slot of the filament diameter sensor 301. FIG. 3b shows a detailed view of the filament diameter sensor 301, having two parts 301a, 301b. In a first part 301a, light source 302 is disposed which is arranged to emit light to a collimator 303. The collimated light 304 is then passed via an aperture 306 in the side wall of the sensor part 301a to the other sensor part 301b, which holds an imaging sensor 307. The collimated light 304 crosses the slot 305 through another aperture 306, in FIG. 3b on the left side of the second element diameter sensor part 301b. The filament 105 will affect the image formed on the imaging sensor 307 for example by casting a shadow in the incident collimated light 304. The imaging sensor can for example be an optical line sensor having pixels arranged in one line, or CCD line sensor, which captures a shadow of the filament passing through the collimated light within the slot 305. This allows a filament diameter of the filament passing through the slot 305 to be estimated, which signal can be passed on to the control unit 205. By actively comparing the measured filament diameter 308 with a preset value, the control unit 205 can control 206 the extrusion drive 109 and control 207 puller 201 to produce a filament 105 with the desired filament diameter. The controlling of the filament diameter can thus be performed based on a difference between the measured filament diameter and the preset filament diameter value

Thus, the filament production apparatus is equipped to produce filament with a controlled diameter. The filament diameter preset value may be constant, but may also vary per batch or period of produced filament, which provides flexibility in use of the filament production apparatus, depending on filament diameter requirements of FDM equipment downstream of the filament production apparatus. No hardware modifications are required for producing various filament diameters, only modification of the preset value is required.

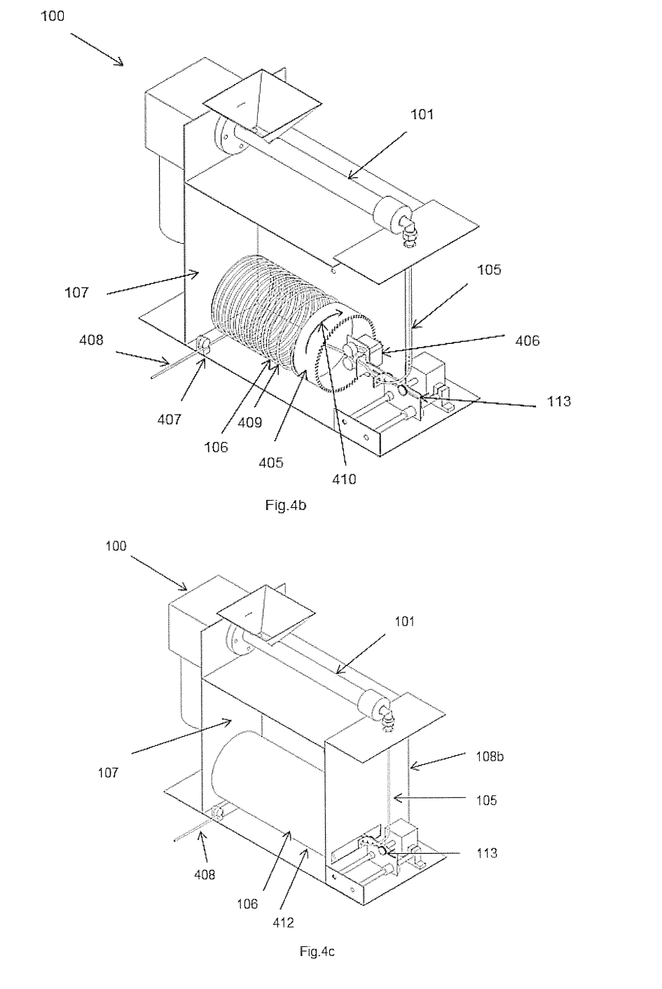

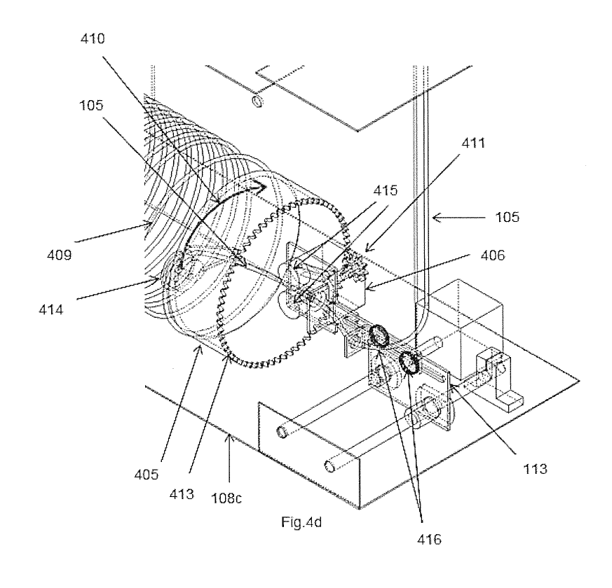

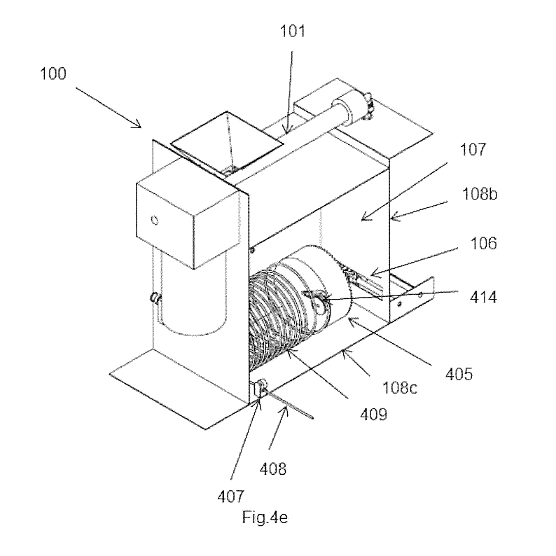

FIG. 4a shows a front view of the FDM filament production apparatus 100 while wherein the filament buffer unit 106 comprises a drive 401. The drive 401 which drives a belt 402, which subsequently drives a spindle 403. On the spindle 403 a reel 404 can be removably mounted, on which the filament 105 extruded from extrusion unit 101 can be wound. The filament guide 113 can be arranged to evenly distribute the filament over with of the filament reel 404 for example by moving it between ultimate positions corresponding to a reel size. At least one of the spindle drive 401 and the spindle 403 can be provided with a slip clutch to compensate for speed differences between extrusion speed of the extrusion unit 101 and the filament reel 404. Alternative ways of driving the reel 404 may be provided, such as directly driving the spindle 403.

FIG. 4b shows a perspective view of the FDM filament production apparatus 100 wherein the filament buffer unit 106 located in the lower section 107 of the apparatus comprises a puller 406 and rotator 405. The puller 406 has a drive and drive wheels which clamp the extruded filament and cause the filament to be pushed into a cylindrical container (see reference number 412 in FIG. 4c). The rotator 405 is driven by a drive in a rotation direction 410. The rotator 405 can for example be driven by the puller drive or a separate drive. The rotator 405 receives the filament 105 via the puller 406 and by its revolving motion 410 it forms a filament coil 409 into the cylindrical container 412. Filament 408 can be extracted from the container 412 via an output 407 depending on filament demand from subsequent devices using the filament 408 from the FDM filament production apparatus 100. This output 407 can optionally comprise a puller. A subsequent device can for example be a fused deposition modeling printer or 3D printer.

FIG. 4c shows a perspective view of the FDM filament production apparatus 100 wherein the cylindrical filament container 412 is shown, which accommodates the filament coil 409. The rotator 405 and puller 406 may also be accommodated by the filament container 412, as shown in FIG. 4c.

FIG. 4d shows a detail from the perspective view of the FDM filament production apparatus 100 of FIG. 1, wherein the filament 105 is guided via guide wheels 416 of the filament guide 113 towards the puller 406. The rotator 405 has a rotatable guide 414 which guides the filament 105 in the rotational motion 410, causing the formation of the filament coil 409 within the filament container 412. The rotator 405 can be cup shaped and is rotationally mounted within the lower section 107. The skilled person will know various alternative solutions for rotationally mounting the rotator within the lower space 107. It can for example have a bearing mounted between a central hollow axle of the rotator 405 within the cup and a support connected to the lower frame section 108c. The rotatable guide 414 extends in this example through the axle holding the rotator 405. The rotator in this example has a serrated rim 413 with teeth cooperating with a gear wheel 411. The gear wheel 411 can be driven independently, or by the same drive which drives the filament wheels 415 of the puller 406 as shown in FIG. 4d.

FIG. 4e shows another perspective view of the FDM filament production apparatus 100 wherein the filament buffer unit 106 located in the lower section 107 of the apparatus wherein the rotator 405, having the rotatable guide 414, is shown together with the filament coil 409. Filament 408 can be extracted via output 407 depending on filament demand from subsequent devices using the filament 409 from the FDM filament production apparatus 100 as described. The rotatable guide 414 extends through the rotator 405 to receive filament 105 from the puller 406. The rotatable guide 414 releases the filament tangentially in an opposite direction as to the rotation direction 410 of the rotator 405 into the container 412. The filament for the filament coil 409 is released near the rotator circumference while rotating the rotator 405 and rotatable guide 414 to make the filament coil 409, accommodated within the filament container 412.

The above described embodiments are given by way of example only. Variations and modifications of the embodiments can be made without departing from the scope of protection as defined by the claims set out below.

### REFERENCE NUMERALS

100 FDM filament production apparatus
101 extrusion unit
102 hopper
103 filament discharge
104 cooling unit
105 filament
106 filament buffer unit
107 lower section
108a-108d frame
109 extrusion drive unit
110 right angle bend
111 extruder barrel
112 heating element
113 filament guide
201 puller
202 fan
203a, 203b puller wheel
204 lever
205 filament diameter controller
301 filament diameter measuring unit
302 light source
303 collimator
304 collimated light
305 slot
306 aperture
307 light sensor
308 sensor signal
401 spindle drive
402 belt
403 spindle
404 reel
405 rotator
406 puller
407 puller
408 filament
409 coiled filament
410 rotation direction
411 rotator gear wheel
412 container
413 cam
414 rotatable guide
415 puller wheel
416 guide wheel

What is claimed is:

1. A FDM filament production apparatus, comprising:
an extrusion unit comprising an extruder, feeding means for feeding FDM raw material into the extrusion unit, a filament discharge opening at an end of the extruder;
a filament cooling unit linked to the filament discharge opening;
a filament buffer unit for receiving and storing the filament from the cooling unit;
a frame for accommodating the extrusion unit, the filament cooling unit and the filament buffer unit;
wherein the extrusion unit is horizontally accommodated in a top section of the frame, having the feeding means on top of the extrusion unit and extending vertically from the extrusion unit;
wherein the filament discharge opening is arranged for substantially vertically downward discharging the extruded filament from the extrusion unit;
wherein the filament cooling unit and filament buffer unit are accommodated in a lower section of the frame below the extrusion unit.

2. The FDM filament production apparatus according to claim 1, wherein the extruder comprises an extruder barrel, at least one rotary extrusion shaft arranged within the extruder barrel, and a drive for driving the rotary extrusion shaft.

3. The FDM filament production apparatus according to claim 2, wherein the extruder comprises at least one heating element for heating the extruder barrel.

4. The FDM filament production apparatus according to claim 1, wherein the filament discharge opening comprises a right angle bend.

5. The FDM filament production apparatus according to claim 1, wherein the filament buffer unit comprises a reel holder, a reel holder drive and an access port for introducing a reel into the filament buffer unit for storing the filament from the filament cooling unit, and filament guide for evenly winding the filament onto the reel.

6. The FDM filament production apparatus according to claim 1, wherein the filament buffer unit comprises a container for storing the filament from the filament cooling unit, and coiling means for coiling up the filament from the filament cooling unit within the container, and a filament output port for outputting the coiled up filament from the container.

7. The FDM filament production apparatus according to claim 6, wherein the coiling means comprise a rotator and a rotatable guide mounted on the rotator, wherein the rotatable guide is arranged for feeding the filament through the rotator and for tangentially releasing and coiling the filament in opposite direction relative to the rotational direction of the rotator.

8. The FDM filament production apparatus according to claim 1, wherein the filament cooling unit is arranged having a port at a top side for receiving the filament from the filament discharge of the extruder, and transport means for substantially vertically downward transporting the filament through the filament cooling means.

9. The FDM filament production apparatus according to claim 8, wherein the filament cooling means comprise a blower arranged for blowing air onto the filament from the filament discharge.

10. The FDM filament production apparatus according to claim 9, further comprising a control unit, and wherein the transport means comprise filament stretching means and wherein the control unit is arranged for controlling the filament stretching means.

11. The FDM filament production apparatus according to claim 10, wherein the control unit is arranged for controlling the filament stretching means transport rate.

12. The FDM filament production apparatus according to claim 11, wherein the control unit is arranged for controlling the filament stretching means transport rate relative to an extruder production rate.

13. The FDM filament production apparatus according to claim 11, further comprising a filament diameter sensor connected to the control unit for sending a filament diameter to the control unit, and wherein the control unit is arranged for controlling the filament stretching means transport rate as a function of the filament diameter and a filament diameter set value.

14. The FDM filament production apparatus according to claim 12, wherein the filament diameter sensor comprises a light source and an optical imaging device for measuring the filament diameter.

15. The FDM filament production apparatus according to claim 3, wherein the filament discharge opening comprises a right angle bend.

16. The FDM filament production apparatus according to claim 15, wherein the filament buffer unit comprises a reel holder, a reel holder drive and an access port for introducing a reel into the filament buffer unit for storing the filament from the filament cooling unit, and filament guide for evenly winding the filament onto the reel.

17. The FDM filament production apparatus according to claim 15, wherein the filament buffer unit comprises a container for storing the filament from the filament cooling unit, and coiling means for coiling up the filament from the filament cooling unit within the container, and a filament output port for outputting the coiled up filament from the container.

18. The FDM filament production apparatus according to claim 17, wherein the coiling means comprise a rotator and a rotatable guide mounted on the rotator, wherein the rotatable guide is arranged for feeding the filament through the rotator and for tangentially releasing and coiling the filament in opposite direction relative to the rotational direction of the rotator, wherein the filament cooling unit is arranged having a port at a top side for receiving the filament from the filament discharge of the extruder, and transport means for substantially vertically downward transporting the filament through the filament cooling means, and wherein the filament cooling means comprise a blower arranged for blowing air onto the filament from the filament discharge.

19. The FDM filament production apparatus according to claim 18, further comprising a control unit, and wherein the transport means comprise filament stretching means and wherein the control unit is arranged for controlling the filament stretching means.

20. The FDM filament production apparatus according to claim 19, wherein the control unit is arranged for controlling the filament stretching means transport rate.
